(19) United States
(12) Patent Application Publication
(10) Pub. No.: US 2004/0153741 A1
(43) Pub. Date: Aug. 5, 2004

(54) Fault tolerant computer, and disk management mechanism and disk management program thereof

(75) Inventor: Hiroaki Obara, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/652,030

(22) Filed: Sep. 2, 2003

(30) Foreign Application Priority Data
Aug. 30, 2002 (JP) 2002-252461

(51) Int. Cl. H02H 3/05

(52) U.S. Cl. 714/7

(57) ABSTRACT

A fault tolerant computer having a disk multiplexing mechanism which multiplexes a plurality of storage devices and an access path multiplexing mechanism which sets and multiplexes a plurality of access paths for the plurality of storage devices, which includes a disk management mechanism which inputs, when a fault such as a failure of the storage device occurs, physical position information of the storage device and operation contents related to the storage device in question to instruct the disk multiplexing mechanism on restoration operation including cut-off and integration operation of the storage device.

### BACKGROUND OF THE INVENTION

1. Field of the Invention

The present invention relates to a lock-step system fault tolerant computer which processes the same instruction string in totally the same manner by a plurality of computing modules in clock synchronization with each other and, more particularly, to a disk management mechanism of a fault tolerant computer which facilitates operation required for multiplexing setting/restoration of a disk.

2. Description of the Related Art

In many of conventional fault tolerant computers of this kind, the disk multiplexing function is realized by software for the purpose of cost cutting.

A fault tolerant computer which realizes disk duplexing by two storage devices for storing an operating system, a user program and user data, for example, is provided with an access path duplexing function of making two or more access paths provided for each of the two storage devices be seen as one from the operating system and a disk duplexing function of making the two storage devices be recognized as one virtual storage device by the operating system, which functions are realized by software for the purpose of cost reduction.

When a fault occurs such as a failure of a storage device, a virtual storage device will be considered as a single point for the fault, so that because of characteristics of a fault tolerant computer, it is necessary to quickly cut off the storage device developing the fault and integrate a normal storage device to again conduct duplexing of a disk.

In a case where an end user conducts disk multiplexing setting or restoration operation by himself/herself in a fault tolerant computer which realizes a disk duplexing function by software, the user needs to execute complicated operation requiring a broader technical knowledge at the time of cutting off a storage device having a failure and integration of a device.

As described above, when an end user conducts cut-off of a storage device developing a failure and integration of a device in a conventional fault tolerant computer which realizes a disk duplexing function by software, as compared with a case where the function is realized by hardware, more complicated operation requiring a broader technical knowledge should be conducted to make it extremely difficult for the end user to conduct the operation in question by himself/herself.

Therefore, because of difficulty of replacement of a disk (storage device) developing a fault by an end user by himself/herself, a large MTBF (Mean Time Between Failure: a mean time from a failure occurring in a computer system until when a next failure occurs) which is a characteristic of a fault tolerant computer is reduced to result in preventing the fault tolerant computer to accomplish its own original object.

In other words, a fault tolerant computer realizing a function for duplexing a disk by software for the purpose of cost reduction has a problem that operability in disk multiplexing setting and restoration is degraded to lose the feature of the fault tolerant computer.

### SUMMARY OF THE INVENTION

An object of the present invention is to provide a disk management mechanism enabling an end user to conduct operation for disk multiplexing setting/restoration with simple operation without requiring a special technical knowledge when a fault such as a failure of a storage device occurs in a fault tolerant computer.

According to the first aspect of the invention, a fault tolerant computer having a disk multiplexing mechanism which multiplexes a plurality of storage devices and an access path multiplexing mechanism which sets and multiplexes a plurality of access paths for the plurality of storage devices, comprising a disk management mechanism which inputs, when a fault such as a failure of the storage device occurs, physical position information of the storage device and operation contents related to the storage device in question to instruct the disk multiplexing mechanism on restoration operation including cut-off and integration operation of the storage device.

According to another aspect of the invention, a disk management mechanism of a fault tolerant computer having a disk multiplexing mechanism which multiplexes a plurality of storage devices and an access path multiplexing mechanism which sets and multiplexes a plurality of access paths for the plurality of storage devices, wherein when a fault such as a failure of the storage device occurs, physical position information of the storage device and operation contents related to the storage device in question are input to instruct the disk multiplexing mechanism on restoration operation including cut-off and integration operation of the storage device.

According to another aspect of the invention, a disk management program of a fault tolerant computer having a disk multiplexing mechanism which multiplexes a plurality of storage devices and an access path multiplexing mechanism which sets and multiplexes a plurality of access paths for the plurality of storage devices, which executes, when a fault such as a failure of the storage device occurs, a function of instructing the disk multiplexing mechanism on restoration operation including cut-off and integration operation of the storage device by inputting physical position information of the storage device and operation contents related to the storage device in question.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing an entire structure of a fault tolerant computer according to an embodiment of the present invention;

FIG. 2 is a block diagram showing a structure of a disk management mechanism of the fault tolerant computer according to the embodiment of the present invention;

FIG. 3 is a diagram for use in explaining the contents of a physical position access path conversion DB of the disk management mechanism shown in FIG. 2; and

FIG. 4 is a sequence diagram for use in explaining operation of the disk management mechanism in the fault tolerant computer according to the embodiment of the present invention.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

Embodiment of the present invention will be described in detail with reference to the drawings in the following.

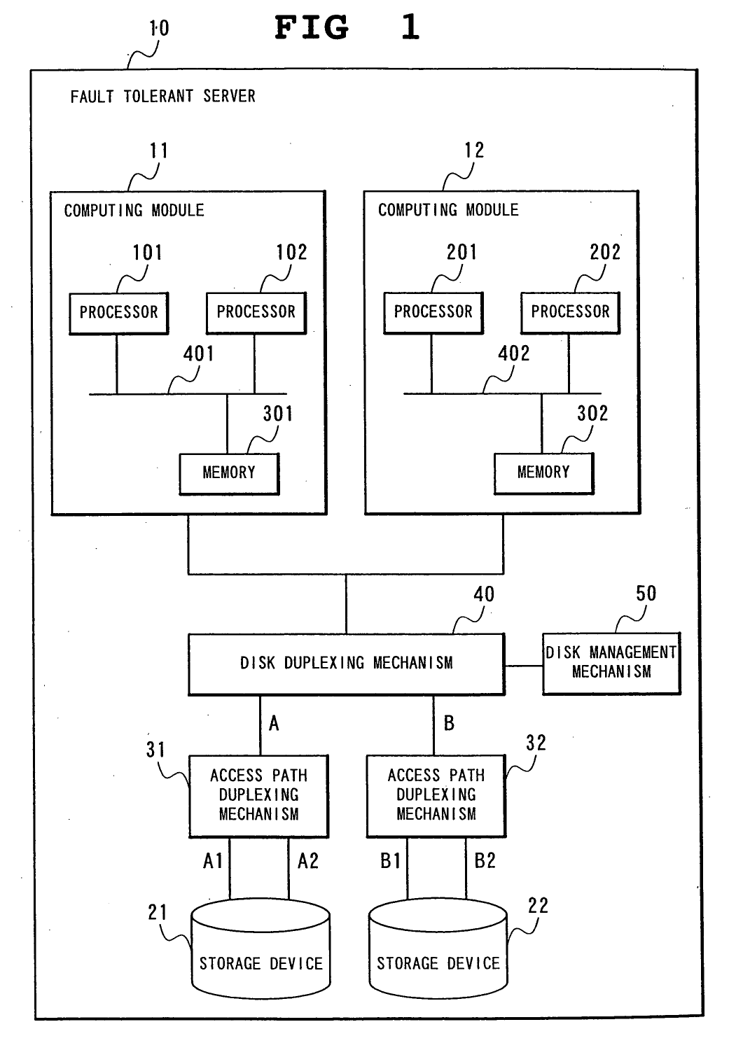

FIG. 1 shows an entire structure of a fault tolerant computer according to an embodiment to which the present invention is applied.

With reference to FIG. 1, a fault tolerant computer 10 according to the present embodiment includes a plurality of computing modules 11 and 12, each of which computing modules 11 and 12 processes the same instruction string in clock synchronization with each other and compares a processing result of each computing module to enable, even when one computing module develops a fault, the processing to be continued by the remaining computing module.

The computing modules 11 and 12 include a plurality of processors 101 and 102, 201 and 202, processor external buses 401 and 402 and memories 301 and 302, respectively.

The fault tolerant server 10 further includes two storage devices 21 and 22 for storing an operating system, a user program or user data, access path duplexing mechanisms 31 and 32 for bundling a plurality of access paths to the two storage devices 21 and 22 into one, a disk duplexing mechanism 40 for making the storage devices 21 and 22 be seen as one from the operating system or the user program through the access path duplexing mechanisms 31 and 32, and a disk management mechanism 50 for accessing the disk duplexing mechanism 40 to provide a simple interface to an end user in disk duplexing setting/restoration operation conducted at the time of restoration or addition of a new storage device when duplexing of a disk is hindered due to a failure of a storage device or a failure in an access path. In FIG. 1, illustration is made only of a characteristic part of the structure of the present embodiment and that of the remaining common part is omitted.

The storage devices 21 and 22 store an operating system, a user program and user data. As a feature of the fault tolerant computer 10, two or more access paths to the storage devices 21 and 22 are provided and for making these access paths be seen as one access path from the operating system, the access path duplexing mechanisms 31 and 32 are provided.

Moreover, although the storage devices 21 and 22 are seen as a total of two storage devices through the access path duplexing mechanisms 31 and 32, the disk duplexing mechanism 40 for duplexing the two storage devices 21 and 22 makes the storage devices 21 and 22 be recognized as one virtual storage device by the operating system.

On the other hand, when a fault such as a failure of the storage devices 21 and 22 occurs, the virtual storage device is considered to be a single point for the fault, so that the storage device developing the fault should be quickly replaced with a normal storage device to again conduct duplexing of the disk because of the characteristics of the fault tolerant computer.

Here, many of low-cost fault tolerant computers implement the disk duplexing mechanism 40 by software and many of the disk duplexing mechanisms 40 realized by software accordingly need complicated processing requiring a broader technical knowledge for cutting off a storage device developing a failure and integration of a new device, whereby an end user will have an extreme difficulty in conducting the relevant processing by himself/herself.

Under these circumstances, the present embodiment is designed such that the disk management mechanism 50 has an interface with the disk duplexing mechanism 40 to take out actual access path information from the access path duplexing mechanisms 31 and 32, thereby mapping information about an access path to a storage device developing a failure and access path information obtained from the access path duplexing mechanism, specify a storage device managed by the disk duplexing mechanism 40 and instruct the disk duplexing mechanism 40 to cut off the storage device in question or integrate a new device.

This arrangement enables an end user to execute replacement of the storage devices 21 and 22 with ease only by grasping a physical position of the storage devices 21 and 22.

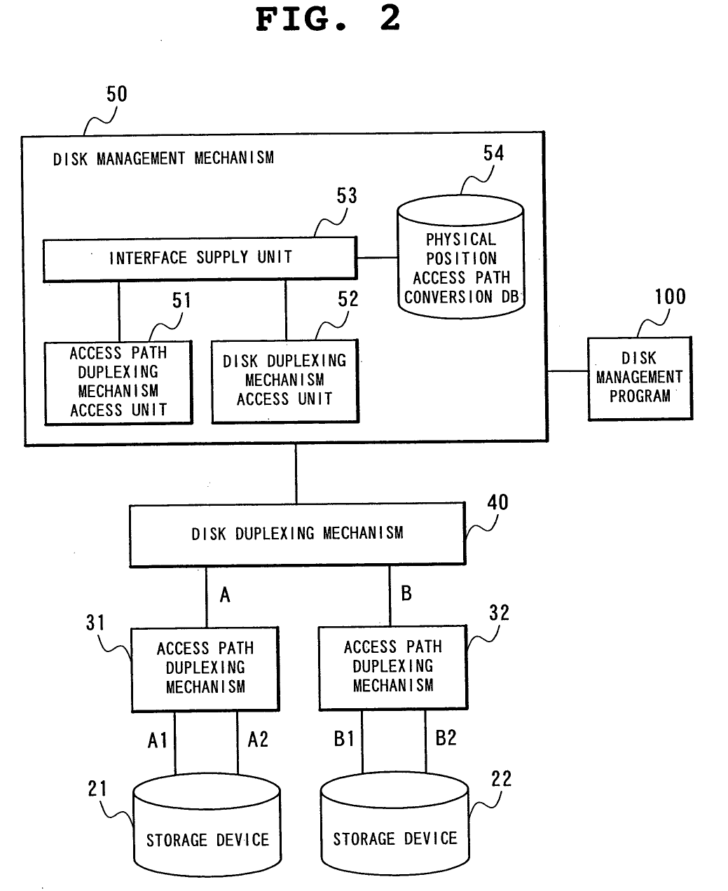

With reference to FIG. 2, the disk management mechanism 50 includes an access path duplexing mechanism access unit 51, a disk duplexing mechanism access unit 52, an interface supply unit 53 and a physical position access path conversion DB (data base) 54.

The access path duplexing mechanism access unit 51 accesses the access path duplexing mechanisms 31 and 32 to obtain information about mapping between the information about the access paths to the storage devices 21 and 22 and access path information duplexed by the access path duplexing mechanisms 31 and 32 which is to be operated by the disk duplexing mechanism 40.

The disk duplexing mechanism access unit 52 accesses and instructs the disk duplexing mechanism 40 on the access path information and a kind of operation (cut-off or integration) to realize cut-off or integration of a specific storage device from or into a virtual storage device.

The interface supply unit 53 obtains access path information of a storage device from the physical position access path conversion DB 54 based on physical position information of the storage device applied by an end user, obtains the access path information and a kind of operation for the disk duplexing mechanism 40 applied by the end user and uses the access path duplexing mechanism access unit 51 and the disk duplexing mechanism access unit 52 to provide the end user with a simple interface.

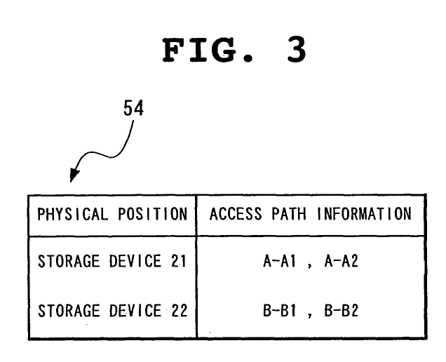

The physical position access path conversion DB 54, as shown in FIG. 3, stores physical position information indicative of the storage devices 21 and 22 and access path information for the storage devices 21 and 22 so as to correspond with each other.

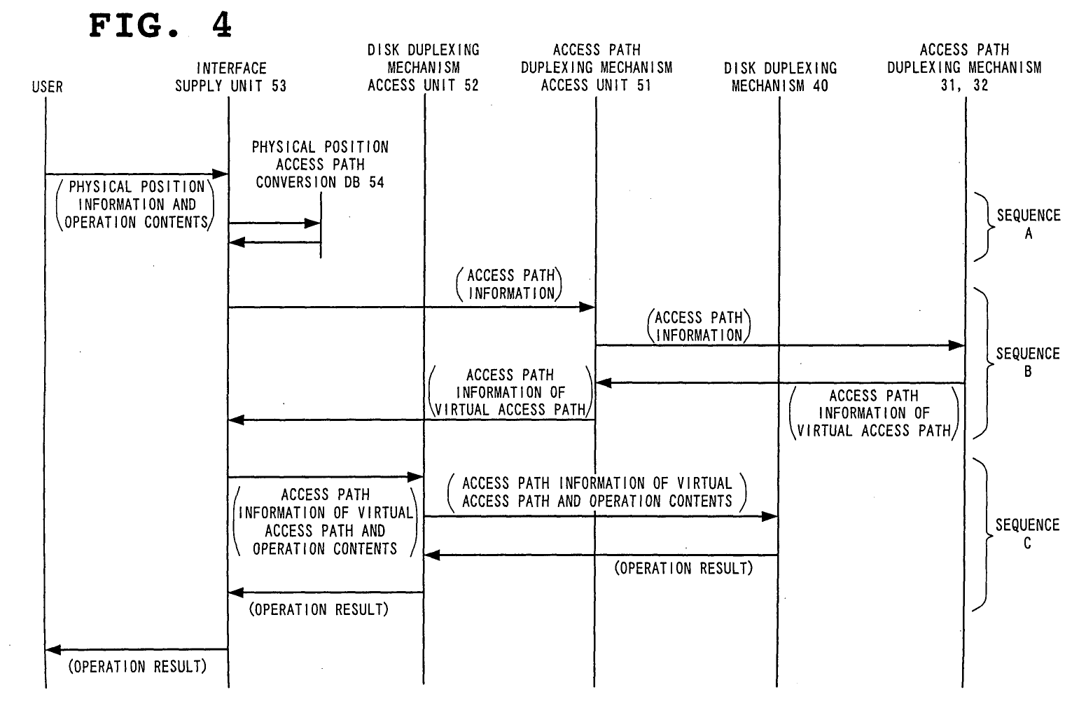

Next, operation of the present embodiment will be detailed with reference to FIG. 2 and the sequence diagram shown in FIG. 4. Assume here, as illustrated in FIG. 2, that access paths which are served for the disk duplexing mechanism 40 to discriminate and control the storage devices 21 and 22 are access paths A and B and that access paths provided by the access path duplexing mechanisms 31 and 32 for the storage devices 21 and 22 are access paths A1, A2 and access paths B1 and B2.

First, an end user applies physical position information of a storage device to be operated (to designate the storage device 21 or the storage device 22) and operation contents (to designate cut-off or integration) to the interface supply unit 53.

Next, the interface supply unit 53 having received the above-described information accesses the physical position access path conversion DB 54 to obtain access path information of the storage device in question from the physical position information (Sequence A in FIG. 4). In a case, for example, where the storage device 21 develops a failure and the storage device 21 is designated as physical position information in order to conduct cut-off of the device or integration, obtained from the physical position access path conversion DB 54 shown in FIG. 3 is information of (access path A—access path A1) and (access path A —access path A2) as access path information corresponding to the storage device 21.

The interface supply unit 53 having obtained the above-described access path information transmits the access path information to the access path duplexing mechanisms 31 and 32 through the access path duplexing mechanism access unit 51.

The access path duplexing mechanisms 31 and 32 having obtained the access path information refer to self-managed access path information and when the transmitted access path information exists, reply to the interface supply unit 53 through the access path duplexing mechanism access unit 51 with access path information composed of a virtual access path which is a path obtained by considering two access paths duplexed by the access path duplexing mechanism 31 or 32 as one access path (Sequence B in FIG. 4).

Here, a virtual access path is a path served for the disk duplexing mechanism 40 to discriminate the storage devices 21 and 22 without using the access paths A1, A2, B1 and B2 and in a case of the access path duplexing mechanism 31, it makes a reply with the access paths A1 and A2 as one virtual access path A which is the same as the access path A.

The disk duplexing mechanism 40 only controls duplexing for the storage devices 21 and 22 through the access paths A and B and grasps nothing about the access paths A1, A2, B1 and B2 provided by the access path duplexing mechanisms 31 and 32. Therefore, for the disk duplexing mechanism 40 to control the storage devices 21 and 22 without using the access paths A1, A2, B1 and B2, such a virtual access path as described above is used.

Furthermore, the interface supply unit 53 transmits access path information for the obtained virtual access path (access path A in a case of the storage device 21) and the operation contents applied by the end user to the disk duplexing mechanism 40 through the disk duplexing mechanism access unit 52. With respect to the designated access path information, the disk duplexing mechanism 40 executes operation designated by the operation contents and replies to the interface supply unit 53 with the operation results through the disk duplexing mechanism access unit 52 (Sequence C in FIG. 4). As a result, the interface supply unit 53 notifies the end user of the operation result.

When a fault such as a failure of the storage devices 21 and 22 occurs, the foregoing operation enables the end user to instruct the disk duplexing mechanism 40 to cut off or integrate the storage device only by simple operation of inputting physical position information which designates a storage device and operation contents related to the storage device, thereby allowing operation required for duplexing setting/restoration to be conducted without a special technical knowledge.

In the fault tolerant computer of the present invention, the function of each unit which executes the disk management function can be realized not only by hardware but also by software by the execution, on a CPU, of a disk management program 100 which executes the function of each of the above-described units. The disk management program 100 is stored in a recording medium such as a magnetic disk or a semiconductor memory and loaded into a memory of the CPU from the recording medium and executed by the CPU to realize each of the above-described functions.

Although the present invention has been described with respect to the preferred embodiment in the foregoing, the present invention is not always limited to the above-described embodiment and can be realized in various forms within the scope of its technical idea.

While the embodiment has been described with respect to a case where two storage devices are duplexed by each disk duplexing mechanism 40, it is apparent that the present invention is similarly applicable to a case where three or more storage devices are multiplexed by a disk multiplexing mechanism. Also as to an access path duplexing mechanism, application of the present invention is not limited to duplexing but is possible to a case where three or more access paths are provided by an access path multiplexing mechanism.

As described in the foregoing, when a fault such as a failure of a storage device occurs, the present invention enables the disk multiplexing mechanism to be instructed on cut-off or integration of a storage device only by simple operation of inputting physical position information which designates a storage device and operation contents of the storage device, whereby an end user is allowed to conduct operation required for multiplexing setting/restoration by extremely simple operation without grasping internal access path information and without having a special technical knowledge.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

1. A fault tolerant computer having a disk multiplexing mechanism which multiplexes a plurality of storage devices and an access path multiplexing mechanism which sets and multiplexes a plurality of access paths for said plurality of storage devices, comprising:
a disk management mechanism which inputs, when a fault such as a failure of said storage device occurs, physical position information of said storage device and operation contents related to the storage device in question to instruct said disk multiplexing mechanism on restoration operation including cut-off and integration operation of said storage device.

2. The fault tolerant computer as set forth in claim 1, wherein
said disk management mechanism includes
a data base which stores said physical position information of said storage device and information about an access path to said storage device so as to correspond with each other for each said storage device.

3. The fault tolerant computer as set forth in claim 2, wherein
said disk management mechanism sends
said access path information corresponding to said physical position information obtained from said data base together with said operation contents to said disk multiplexing mechanism to instruct on restoration operation including cut-off and integration operation of said storage device.

4. The fault tolerant computer as set forth in claim 2, further comprising:
first access element which sends said access path information corresponding to said physical position information obtained from said data base to said access path multiplexing mechanism to receive, from said access path multiplexing mechanism which manages said access path information, a virtual access path served for said disk multiplexing mechanism to recognize said storage device, which is a virtual access path obtained by bundling said plurality of access paths into one, and
second access element which sends path information composed of said virtual access path received by said first access element and said operation contents to said disk multiplexing mechanism.

5. The fault tolerant computer as set forth in claim 2, wherein
said disk management mechanism includes
interface element which receives input of physical position information of said storage device and operation contents related to the storage device in question, as well as receives operation results of said operation contents from said disk multiplexing mechanism.

6. The fault tolerant computer as set forth in claim 2, further comprising:
first access element which sends said access path information corresponding to said physical position information obtained from said data base to said access path multiplexing mechanism to receive, from said access path multiplexing mechanism which manages said access path information, a virtual access path served for said disk multiplexing mechanism to recognize said storage device, which is a virtual access path obtained by bundling said plurality of access paths into one, and
second access element which sends path information composed of said virtual access path received by said first access element and said operation contents to said disk multiplexing mechanism, wherein
said disk management mechanism includes
interface element which receives input of physical position information of said storage device and operation contents related to the storage device in question, as well as receives operation results of said operation contents from said disk multiplexing mechanism.

7. A disk management mechanism of a fault tolerant computer having a disk multiplexing mechanism which multiplexes a plurality of storage devices and an access path multiplexing mechanism which sets and multiplexes a plurality of access paths for said plurality of storage devices, wherein
when a fault such as a failure of said storage device occurs, physical position information of said storage device and operation contents related to the storage device in question are input to instruct said disk multiplexing mechanism on restoration operation including cut-off and integration operation of said storage device.

8. The disk management mechanism of a fault tolerant computer as set forth in claim 7, including
a data base which stores said physical position information of said storage device and information about an access path to said storage device so as to correspond with each other for each said storage device.

9. The disk management mechanism of a fault tolerant computer as set forth in claim 8, wherein
said access path information corresponding to said physical position information obtained from said data base is sent together with said operation contents to said disk multiplexing mechanism to instruct on restoration operation including cut-off and integration operation of said storage device.

10. The disk management mechanism of a fault tolerant computer as set forth in claim 8, further comprising:
first access element which sends said access path information corresponding to said physical position information obtained from said data base to said access path multiplexing mechanism to receive, from said access path multiplexing mechanism which manages said access path information, a virtual access path served for said disk multiplexing mechanism to recognize said storage device, which is a virtual access path obtained by bundling said plurality of access paths into one, and
second access element which sends path information composed of said virtual access path received by said first access element and said operation contents to said disk multiplexing mechanism.

11. The disk management mechanism of a fault tolerant computer as set forth in claim 8, further comprising
interface element which receives input of physical position information of said storage device and operation contents related to the storage device in question, as well as receives operation results of said operation contents from said disk multiplexing mechanism.

12. The disk management mechanism of a fault tolerant computer as set forth in claim 8, further comprising:
first access element which sends said access path information corresponding to said physical position information obtained from said data base to said access path multiplexing mechanism to receive, from said access path multiplexing mechanism which manages said access path information, a virtual access path served for said disk multiplexing mechanism to recognize said storage device, which is a virtual access path obtained by bundling said plurality of access paths into one,
second access element which sends path information composed of said virtual access path received by said first access element and said operation contents to said disk multiplexing mechanism, and
interface element which receives input of physical position information of said storage device and operation contents related to the storage device in question, as well as receives operation results of said operation contents from said disk multiplexing mechanism.

13. A disk management program of a fault tolerant computer having a disk multiplexing mechanism which multiplexes a plurality of storage devices and an access path multiplexing mechanism which sets and multiplexes a plurality of access paths for said plurality of storage devices, which executes,
when a fault such as a failure of said storage device occurs, a function of instructing said disk multiplexing mechanism on restoration operation including cut-off and integration operation of said storage device by inputting physical position information of said storage device and operation contents related to the storage device in question.

14. The disk management program of a fault tolerant computer as set forth in claim 13, which executes the functions of:
sending, to said access path multiplexing mechanism, access path information corresponding to said physical position information obtained from a data base which stores said physical position information of said storage device and said access path information to said storage device so as to correspond with each other for each said storage device and receiving, from said access path multiplexing mechanism which manages said access path information, a virtual access path served for said disk multiplexing mechanism to recognize said storage device, which is a virtual access path obtained by bundling said plurality of access paths into one, and
sending path information composed of said virtual access path received and said operation contents to said disk multiplexing mechanism.

15. The disk management program of a fault tolerant computer as set forth in claim 14, which executes
an interface function of receiving input of physical position information of said storage device and operation contents related to the storage device in question, as well as receiving operation results of said operation contents from said disk multiplexing mechanism.
